(19) United States
(12) Patent Application Publication
(10) Pub. No.: US 2026/0303414 A1
(43) Pub. Date: Oct. 1, 2026

(54) CHANNEL SOUNDING METHOD USING SINGLE-TONE SIGNAL WITH AT LEAST ONE SECURITY MARKER EMBEDDED THEREIN AND ASSOCIATED WIRELESS COMMUNICATION DEVICE

(71) Applicant: Airoha Technology Corp., Hsinchu City (TW)

(72) Inventors: Jeng-Hong Chen, Manhattan Beach, CA (US); Chin-Chang Chang, Tainan City (TW); Yun-Xuan Zhang, Hsinchu County (TW); Yu-Hsiu Lin, Hsinchu County (TW); Yu-Chung Tseng, Hsinchu County (TW); Meng-Yuan Cheng, Hsinchu County (TW)

(73) Assignee: Airoha Technology Corp., Hsinchu City (TW)

(21) Appl. No.: 19/438,681

(22) Filed: Jan. 2, 2026

Related U.S. Application Data
(60) Provisional application No. 63/777,717, filed on Mar. 26, 2025.

(51) Int. Cl. H04L 25/02; G01S 1/04

(52) U.S. Cl. CPC H04L 25/0226; G01S 1/0428; G01S 1/045

(57) ABSTRACT

A channel sounding method is used for performing distance estimation based on phase-based ranging, and includes: generating a first single-tone signal with at least one security marker embedded therein for a first tone duration; and during the first tone duration, transmitting the first single-tone signal from a first wireless communication device to a second wireless communication device.

### CROSS REFERENCE TO RELATED APPLICATIONS

This application claims the benefit of U.S. Provisional Application No. 63/777,717, filed on Mar. 26, 2025. The content of the application is incorporated herein by reference.

### BACKGROUND OF THE INVENTION

### 1. Field of the Invention

The present invention relates to a channel sounding technique, and more particularly, to a channel sounding method using a single-tone signal with at least one security marker embedded therein and an associated wireless communication device.

### 2. Description of the Prior Art

Bluetooth channel sounding supports two ranging methods, phase-based ranging (PBR) and round-trip time (RTT), to enable distance estimation between Bluetooth connected devices. The Bluetooth channel sounding leverages PBR to achieve precise distance measurements between two devices. In PBR, an initiator device sends a signal to a reflector device, which returns the signal. The distance between the devices is calculated based on the phase differences between the transmitted and received signals. The Bluetooth channel sounding leverages RTT to achieve secure distance measurements between two devices. In RTT, an initiator device sends cryptographically scrambled packets (which are not single-tone signals) to a reflector device, which returns the packets. The distance between the devices is then calculated based on the time it took for the packets to travel back and forth. Compared to the RTT approach, the PBR approach provides a more accurate distance measurement, but is subject to malicious attacks. Thus, there is a need for an innovative channel sounding design which is capable of enabling secure and accurate distance measurements between devices.

### SUMMARY OF THE INVENTION

One of the objectives of the claimed invention is to provide a channel sounding method using a single-tone signal with at least one security marker embedded therein and an associated wireless communication device.

According to a first aspect of the present invention, an exemplary channel sounding method for performing distance estimation based on phase-based ranging is disclosed. The exemplary channel sounding method includes: generating a first single-tone signal with at least one security marker embedded therein for a first tone duration; and during the first tone duration, transmitting the first single-tone signal from a first wireless communication device to a second wireless communication device.

According to a second aspect of the present invention, an exemplary wireless communication device of performing channel sounding for distance estimation based on phase-based ranging is disclosed. The exemplary wireless communication device includes a signal generator circuit and a transmitter circuit. The signal generator circuit is configured to generate a first single-tone signal with at least one security marker embedded therein for a first tone duration. The transmitter circuit is configured to transmit the first single-tone signal from the wireless communication device to another wireless communication device during the first tone duration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a channel sounding system according to an embodiment of the present invention.

FIG. 2 is a sequence diagram illustrating interactions between an initiator device and a reflector device according to an embodiment of the present invention.

FIG. 3 is a diagram illustrating a conventional single-tone signal without a security marker and a proposed single-tone signal with a security marker.

FIG. 4 is a diagram illustrating a single-tone signal with two identical security markers according to an embodiment of the present invention.

FIG. 5 is a diagram illustrating a single-tone signal with two different security markers according to an embodiment of the present invention.

FIG. 6 is a diagram illustrating a single-tone signal with two different security markers (which have different unique waveforms to serve as different unique security signatures) according to an embodiment of the present invention.

FIG. 7 is a diagram illustrating a first unique waveform for serving as a unique security signature according to an embodiment of the present invention.

FIG. 8 is a diagram illustrating a second unique waveform for serving as a unique security signature according to an embodiment of the present invention.

FIG. 9 is a diagram illustrating a third unique waveform for serving as a unique security signature according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

Both security and accuracy are critical requirements of a ranging method. Thus, there is a need for an innovative channel sounding design which is capable of enabling secure and accurate PBR-based distance measurements between devices.

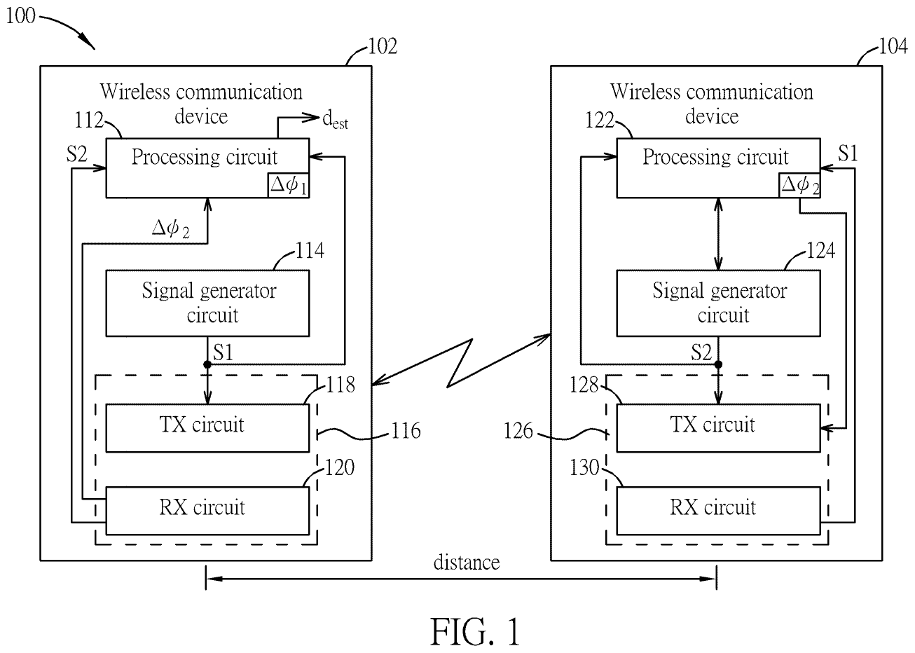

FIG. 1 is a diagram illustrating a channel sounding system according to an embodiment of the present invention. The channel sounding system 100 includes a plurality of wireless communication devices 102 and 104. For example, the wireless communication devices 102 and 104 are Bluetooth (BT) devices such as Bluetooth Low Energy (BLE) devices. In this embodiment, the channel sounding system 100 employs a channel sounding method for performing distance estimation based on phase-based ranging (PBR), where the wireless communication device 102 may act as an initiator device, and the wireless communication device 104 may act as a reflector device. The wireless communication device 102 includes a processing circuit 112, a signal generator circuit 114, and a transceiver circuit 116, where the transceiver circuit 116 includes a transmitter (TX) circuit 118 and a receiver (RX) circuit 120. The wireless communication device 104 includes a processing circuit 122, a signal generator circuit 124, and a transceiver circuit 126, where the transceiver circuit 126 includes a TX circuit 128 and an RX circuit 130.

It should be noted that only the components pertinent to the present invention are shown in FIG. 1. In practice, the wireless communication device 102 may include additional components to achieve other designed functions, and/or the wireless communication device 104 may include additional components to achieve other designed functions.

The distance between wireless communication devices 102 and 104 can be estimated using the proposed secure PBR scheme. Specifically, the signal generator circuit 114 is configured to generate a single-tone signal (i.e., a sinusoidal signal) S1 with at least one security marker embedded therein for a tone duration, and the TX circuit 118 is configured to transmit the single-tone signal S1 (which has at least one security marker embedded therein) to the wireless communication device (which acts as the reflector device) 104. In addition, the signal generator circuit 124 is configured to generate a single-tone signal (i.e., a sinusoidal signal) S2 with at least one security marker embedded therein for a tone duration, and the TX circuit 128 is configured to transmit the single-tone signal S2 (which has at least one security marker embedded therein) to the wireless communication device (which acts as the initiator device) 102.

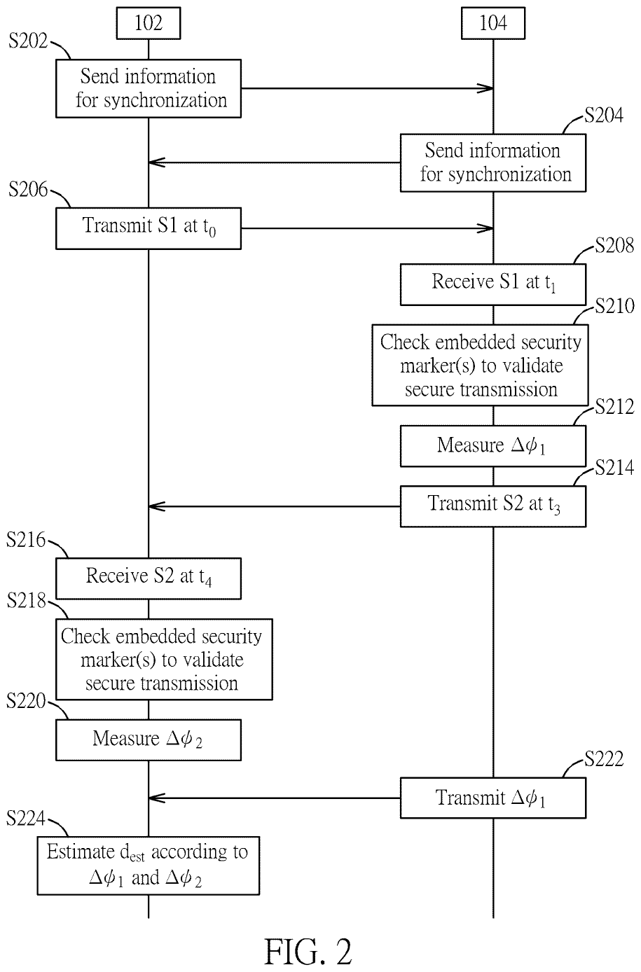

Please refer to FIG. 2 in conjunction with FIG. 1. FIG. 2 is a sequence diagram illustrating interactions between an initiator device and a reflector device according to an embodiment of the present invention. Before a channel sounding procedure starts, the wireless communication device (which acts as the initiator device) 102 and the wireless communication device (which acts as the reflector device) 104 may exchange information for frequency and timing synchronization (step S202 and S204). For example, with the help of an information exchange procedure, the wireless communication devices 102 and 104 have synchronized at the same frequency ω₀; the wireless communication devices 102 and 104 have scheduled at a time instant t₀ for the wireless communication device 102 to transmit the single-tone signal S1 to the wireless communication device 104 for a tone duration L1; a measured phase difference Δφ₁ is transmitted from the wireless communication device 104 to the wireless communication device 102; and the wireless communication devices 102 and 104 have scheduled at a time instant t₃ for the wireless communication device 104 to transmit the single-tone signal S2 to the wireless communication device 102 for a tone duration L2.

In addition, the synchronization procedure (steps S202 and S204) between the wireless communication devices 102 and 104 may be further used to negotiate the number of security markers embedded in a single-tone signal for a tone duration, the location of each security marker embedded in a single-tone signal for a tone duration, the duration of each security marker embedded in a single-tone signal for a tone duration, and/or the waveform of each security marker embedded in a single-tone signal for a tone duration. In other words, before transmission of single-tone signals S1 and S2, the wireless communication devices 102 and 104 share information of security marker settings through secure communications.

At the scheduled time instant to, the TX circuit 118 of the wireless communication device 102 transmits the single-tone signal S1 at the frequency ω₀ (step S206). At a time instant t₁, the RX circuit 130 of the wireless communication device 104 receives the single-tone signal S1 (step S204), where

$${t}_{1} = {t}_{0} + \frac{d}{C}$$

under a condition that the distance between wireless communication devices 102 and 104 is d and the single-tone signal S1 travels through a physical medium (e.g., air) at the speed of light C.

In step S210, the processing circuit 122 checks if one or more security markers are embedded in the single-tone signal S1 to validate secure transmission of the single-tone signal S1 from the initiator device (i.e., wireless communication device 102). For example, the number, the location(s), the duration(s), and the signature (waveform) of unique security marker(s) which are pre-known to the wireless communication devices 102 and 104 only. The information of security marker(s) may be exchanged in steps S202 and S204. If validation fails due to absence of expected security marker(s), the reflector device (i.e., wireless communication device 104) discards reception of the unsecure single-tone signal during the tone duration L1. If presence of expected security marker(s) is confirmed, the processing circuit 122 measures a phase difference Δφ₁ between a phase of the received single-tone signal S1 and a phase of the local single-tone signal S2 (step S212).

The phase trajectory of the local single-tone signal S1 at the wireless communication device 102 may be expressed using the following equation, where θ_{A} is an initial phase of the local single-tone signal S1.

$${ϕ}_{A} ( t ) = {θ}_{A} + {ω}_{0} t \qquad ( 1 )$$

The phase trajectory of the local single-tone signal S2 at the wireless communication device 104 may be expressed using the following equation, where θ_{B} is an initial phase of the local single-tone signal S2.

$${ϕ}_{B} ( t ) = {θ}_{B} + {ω}_{0} t \qquad ( 2 )$$

The delayed phase trajectory of the single-tone signal S1 received by the wireless communication device 104 after propagation may be expressed using the following equation, where t_{d} represents a propagation time of the single-tone signal S1 from the wireless communication device 102 to the wireless communication device 104.

$${ϕ}_{A} ( t - {t}_{d} ) = {θ}_{A} + {ω}_{0} ( t - {t}_{d} ) \qquad ( 3 )$$

When the single-tone signal S1 is received by the wireless communication device 104 at the time instant t₁, the phase of the single-tone signal S1 at the time instant t₁ may be expressed using the following equation.

$${ϕ}_{A} ( t - {t}_{1} - {t}_{d} ) = {θ}_{A} + {ω}_{0} ( t - {t}_{1} - {t}_{d} ) \qquad ( 4 )$$

The phase of the single-tone signal S2 at the time instant t₁ may be expressed using the following equation.

$${ϕ}_{B} ( t - {t}_{1} ) = {θ}_{B} + {ω}_{0} ( t - {t}_{1} ) \qquad ( 5 )$$

The computation of the phase difference Δφ₁ at the wireless communication device 104 may be expressed using the following equation.

$$Δ {ϕ}_{1} = {ϕ}_{B} ( t - {t}_{1} ) - {ϕ}_{A} ( t - {t}_{1} - {t}_{d} ) = ( {θ}_{B} - {θ}_{A} ) + {ω}_{0} {t}_{d} \qquad ( 6 )$$

All segments of the single-tone signal S1 except security marker(s) can be used for computation of the phase difference Δφ₁. During the tone duration L1, phase differences Δφ₁ obtained from different non-security-marker segments of the single-tone signal S1 may be summed and then averaged to determine a final value of the phase difference Δφ₁. However, this is for illustrative purposes only, and is not meant to be a limitation of the present invention.

At the scheduled time instant t₃, the TX circuit 128 of the wireless communication device 104 transmits the single-tone signal S2 at the frequency ω₀ (step S214). At a time instant t₄, the RX circuit 120 of the wireless communication device 102 receives the single-tone signal S2 (step S216), where

$${t}_{4} = {t}_{3} + \frac{d}{C}$$

under a condition that the distance between wireless communication devices 102 and 104 is d and the single-tone signal S2 travels through a physical medium (e.g., air) at the speed of light C.

In step S218, the processing circuit 112 checks if one or more security markers are embedded in the single-tone signal S2 to validate secure transmission of the single-tone signal S2 from the reflector device (i.e., wireless communication device 104). For example, the number, the location(s), the duration(s), and the signature (waveform) of unique security marker(s) which are pre-known to the wireless communication devices 102 and 104 only. The information of security marker(s) may be exchanged in steps S202 and S204. If validation fails due to absence of expected security marker(s), the initiator device (i.e., wireless communication device 102) discards reception of the unsecure single-tone signal during the tone duration L2. If presence of expected security marker(s) is confirmed, the processing circuit 112 measures a phase difference Δφ₂ between a phase of the received single-tone signal S2 and a phase of the local single-tone signal S1 (step S220).

The delayed phase trajectory of the single-tone signal S2 received by the wireless communication device 102 after propagation may be expressed using the following equation, where t_{d} represents a propagation time of the single-tone signal S2 from the wireless communication device 104 to the wireless communication device 102.

$${ϕ}_{B} ( t - {t}_{d} ) = {θ}_{B} + {ω}_{0} ( t - {t}_{d} ) \qquad ( 7 )$$

When the single-tone signal S2 is received by the wireless communication device 102 at the time instant t₄, the phase of the single-tone signal S2 at the time instant t₄ may be expressed using the following equation.

$${ϕ}_{B} ( t - {t}_{4} - {t}_{d} ) = {θ}_{B} + {ω}_{0} ( t - {t}_{4} - {t}_{d} ) \qquad ( 8 )$$

The phase of the single-tone signal S1 at the time instant t₄ may be expressed using the following equation.

$${ϕ}_{A} ( t - {t}_{4} ) = {θ}_{A} + {ω}_{0} ( t - {t}_{4} ) \qquad ( 9 )$$

The computation of the phase difference Δφ₂ at the wireless communication device 102 may be expressed using the following equation.

$$Δ {ϕ}_{2} = {ϕ}_{A} ( t - {t}_{4} ) - {ϕ}_{B} ( t - {t}_{4} - {t}_{d} ) = ( {θ}_{A} - {θ}_{B} ) + {ω}_{0} {t}_{d} \qquad ( 10 )$$

All segments of the single-tone signal S2 except security marker(s) can be used for computation of the phase difference Δφ₂. During the tone duration L2, phase differences Δφ₂ obtained from different non-security-marker segments of the single-tone signal S2 may be summed and then averaged to determine a final value of the phase difference Δφ₂. However, this is for illustrative purposes only, and is not meant to be a limitation of the present invention.

After the measured phase difference Δφ₁ is obtained at step S212, the TX circuit 128 of the wireless communication device 104 further transmits the measured phase difference Δφ₁ to the wireless communication device 102 (step S222). It should be noted that the timing when the measured phase difference Δφ₁ is provided to the wireless communication device 102 may be adjusted, depending upon actual design considerations.

In step S224, the processing circuit 112 estimates the distance d between wireless communication devices 102 and 104 according to the measured phase differences Δφ₁ and Δφ₂. For example, computation of an estimated distance dₑₛₜ may be expressed using the following equations, where C is the speed of light travelling through a physical medium (e.g., air) between wireless communication devices 102 and 104.

$$Δ ϕ = Δ {ϕ}_{1} + Δ {ϕ}_{2} = 2 {ω}_{0} {t}_{d} \qquad ( 11 )$$

$${t}_{d} = \frac{d}{C} \qquad ( 12 )$$

$${d}_{est} = {t}_{d} \times C = \frac{C \times Δ ϕ}{2 {ω}_{0}} \qquad ( 13 )$$

The present invention proposes embedding one or more security markers within the single-tone signal S1 that is transmitted from the initiator device (i.e., wireless communication device 102) and received by the reflector device (i.e., wireless communication device 104) for a tone duration L1, and/or embedding one or more security markers within the single-tone signal S2 that is transmitted from the reflector device (i.e., wireless communication device 104) and received by the initiator device (i.e., wireless communication device 102) for a tone duration L2.

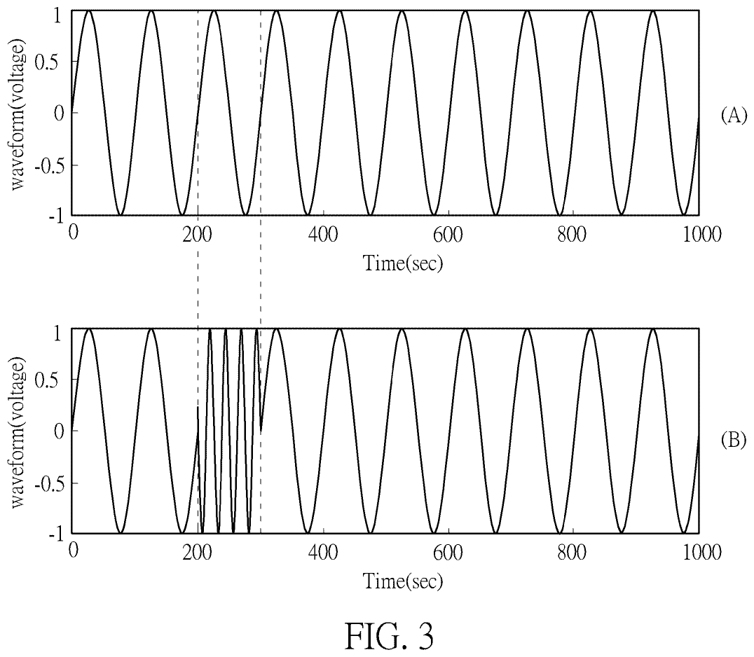

FIG. 3 is a diagram illustrating a conventional single-tone signal without a security marker and a proposed single-tone signal with a security marker. As shown in sub-diagram (A) of FIG. 3, the conventional single-tone signal has a normal sine wave segment within a time period [200:300]. As shown in sub-diagram (B) of FIG. 3, the proposed single-tone signal has a security marker within the time period [200:300], where a waveform of the security marker is different from a normal sine wave segment possessed by the conventional single-tone signal. Specifically, the waveform of the security marker embedded in the proposed single-tone signal is different from waveforms of other sine wave segments of the proposed single-tone signal. For example, one or more properties (e.g., a frequency and/or a unique waveform) of the security marker embedded in the proposed single-tone signal are different from that of other sine wave segments of the proposed single-tone signal. Hence, the security marker can be used to validate secure transmission of the single-tone signal used for channel sounding (particularly, PBR-based distance estimation).

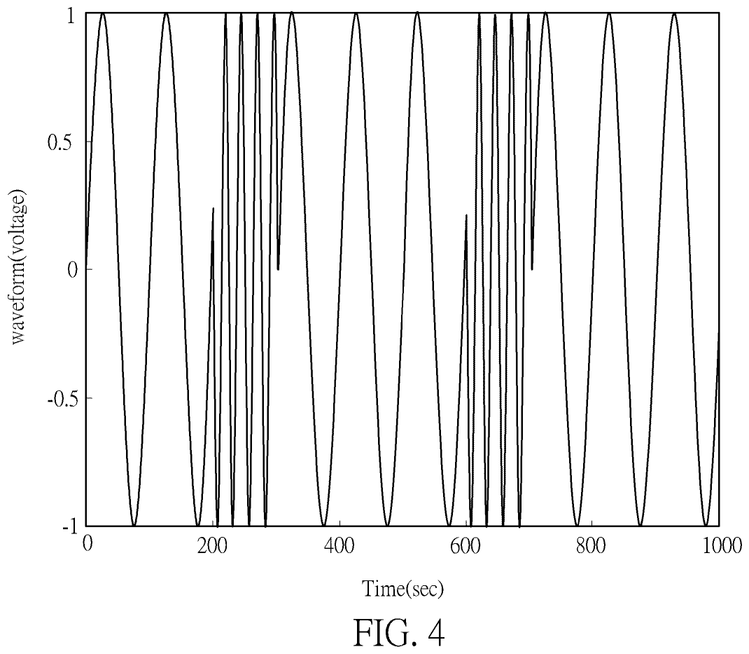

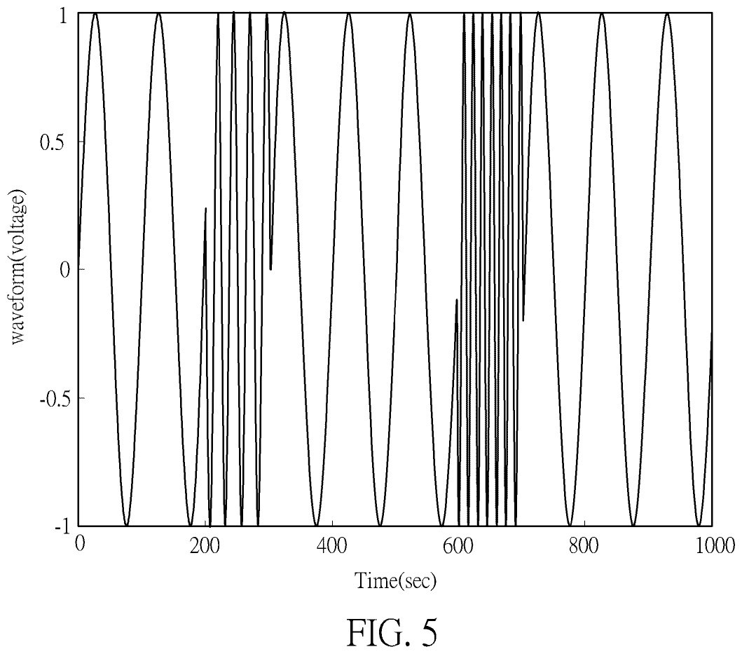

It should be noted that the number of security markers embedded in the single-tone signal S1/S2 may be adjusted, depending upon actual design considerations. FIG. 4 is a diagram illustrating a single-tone signal with two identical security markers according to an embodiment of the present invention. As shown in FIG. 4, a waveform of a first security marker within one time period [200:300] is the same as a waveform of a second security marker within another time period [600:700]. FIG. 5 is a diagram illustrating a single-tone signal with two different security markers according to an embodiment of the present invention. As shown in FIG. 5, a waveform of a first security marker within one time period [200:300] is different from a waveform of a second security marker within another time period [600:700].

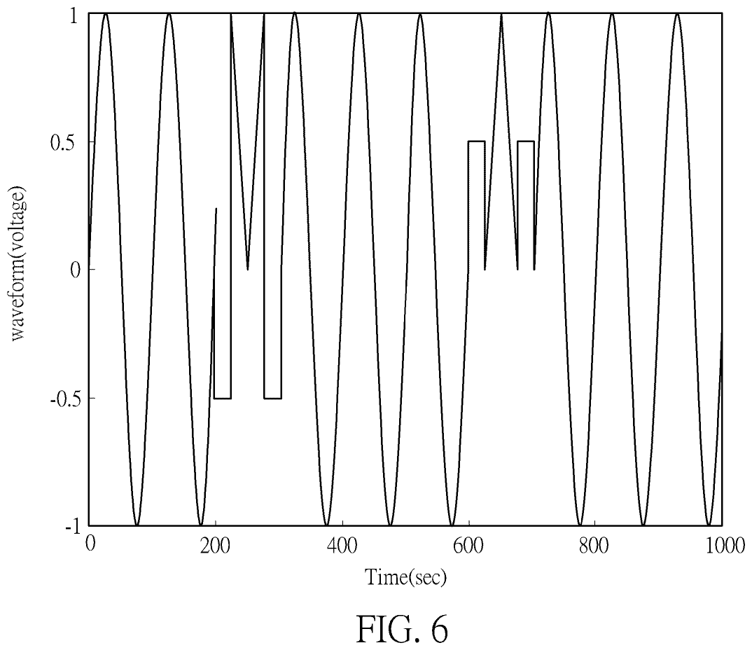

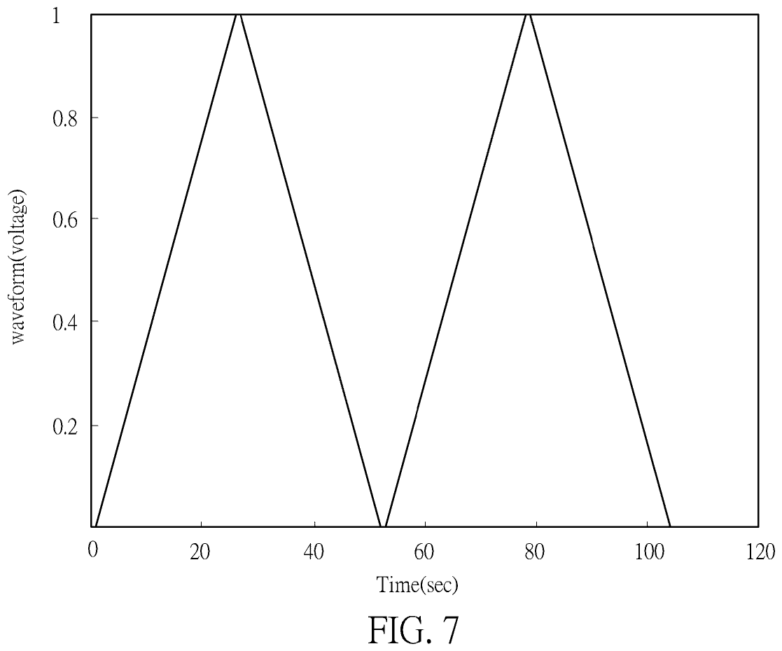

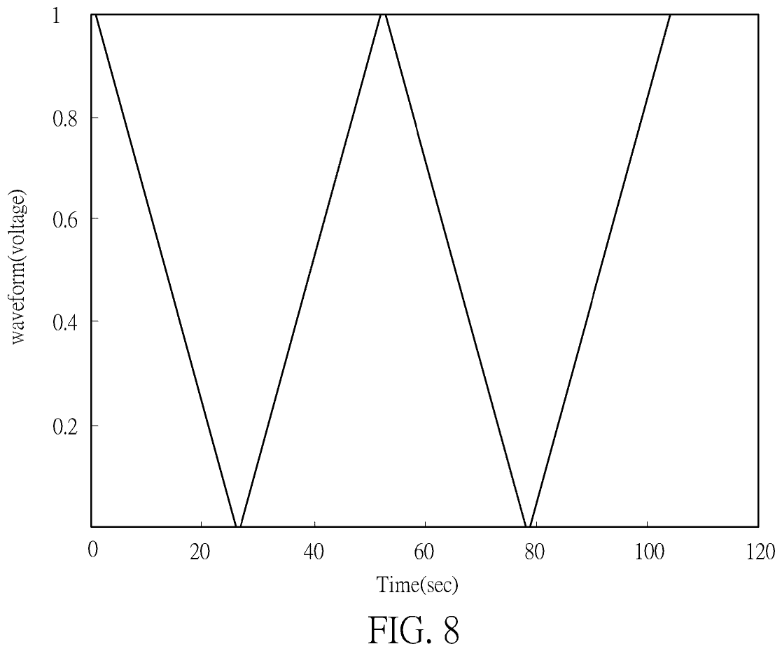

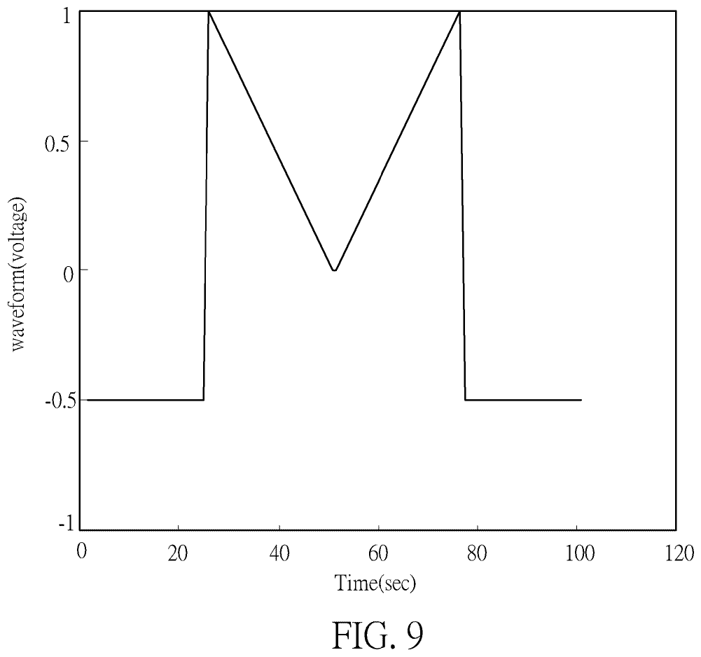

In some embodiments of the present invention, the TX side may implement a unique waveform (which serves as a unique security signature) that is known to the RX side to further enhance the security of transmission of a single-tone signal from the TX side to the RX side. FIG. 6 is a diagram illustrating a single-tone signal with two different security markers (which have different unique waveforms to serve as different unique security signatures) according to an embodiment of the present invention. FIG. 7 is a diagram illustrating a first unique waveform for serving as a unique security signature according to an embodiment of the present invention. FIG. 8 is a diagram illustrating a second unique waveform for serving as a unique security signature according to an embodiment of the present invention. FIG. 9 is a diagram illustrating a third unique waveform for serving as a unique security signature according to an embodiment of the present invention.

As mentioned above, the synchronization procedure (steps S202 and S204) between the wireless communication devices 102 and 104 may be further used to negotiate the number of security markers embedded in a single-tone signal for a tone duration, the location of each security marker embedded in a single-tone signal for a tone duration, the duration of each security marker embedded in a single-tone signal for a tone duration, and/or the waveform of each security marker embedded in a single-tone signal for a tone duration. For example, at least a portion (i.e., part or all) of security marker settings, including the number of security markers, the location of each security marker, the duration of each security marker, and the waveform of each security marker, may have specified (fixed) settings known to both of the wireless communication devices 102 and 104. For another example, at least a portion (i.e., part or all) of security marker settings, including the number of security markers, the location of each security marker, the duration of each security marker, and the waveform of each security marker, may have randomized settings determined by random functions with random seeds known to both of the wireless communication devices 102 and 104. To put it simply, any PBR-based distance estimation application using the proposed single-tone signal with embedded security marker(s) for security enhancement falls within the scope of the present invention.

In some embodiments of the present invention, the number of security markers embedded in the single-tone signal S1 is known to both of the wireless communication devices 102 and 104 before transmission of the single-tone signal S1, and/or the number of security markers embedded in the single-tone signal S2 is known to both of the wireless communication devices 102 and 104 before transmission of the single-tone signal S2.

In some embodiments of the present invention, the location of each security marker embedded in the single-tone signal S1 is known to both of the wireless communication devices 102 and 104 before transmission of the single-tone signal S1, and/or the location of each security marker embedded in the single-tone signal S2 is known to both of the wireless communication devices 102 and 104 before transmission of the single-tone signal S2.

In some embodiments of the present invention, the duration of each security marker embedded in the single-tone signal S1 is known to both of the wireless communication devices 102 and 104 before transmission of the single-tone signal S1, and/or the duration of each security marker embedded in the single-tone signal S2 is known to both of the wireless communication devices 102 and 104 before transmission of the single-tone signal S2.

In some embodiments of the present invention, the waveform of each security marker embedded in the single-tone signal S1 may be known to both of the wireless communication devices 102 and 104 before transmission of the single-tone signal S1, and/or the waveform of each security marker embedded in the single-tone signal S2 may be known to both of the wireless communication devices 102 and 104 before transmission of the single-tone signal S2.

In some embodiments of the present invention, the waveform of each security marker embedded in the single-tone signal S1 may be unknown to the wireless communication device 104 before transmission of the single-tone signal S1, and/or the waveform of each security marker embedded in the single-tone signal S2 may be unknown to the wireless communication device 102 before transmission of the single-tone signal S2.

It should be noted that the signal generator circuit 114 may be further configured to generate another single-tone signal S1′ with at least one security marker embedded therein for another tone duration L1′, and the TX circuit 118 may be further configured to transmit the single-tone signal S1′ to the wireless communication device 104 during the tone duration L1′; and the signal generator circuit 124 may be further configured to generate another single-tone signal S2′ with at least one security marker embedded therein for another tone duration L2′, and the TX circuit 128 may be further configured to transmit the single-tone signal S2′ to the wireless communication device 102 during the tone duration L2′.

In some embodiments of the present invention, the location of a security marker embedded in the single-tone signal S1′ may be identical to the location of a security marker embedded in the single-tone signal S1, and/or the location of a security marker embedded in the single-tone signal S2′ may be identical to the location of a security marker embedded in the single-tone signal S2.

In some embodiments of the present invention, the location of a security marker embedded in the single-tone signal S1′ may be different from the location of a security marker embedded in the single-tone signal S1 for security enhancement, and/or the location of a security marker embedded in the single-tone signal S2′ may be different from the location of a security marker embedded in the single-tone signal S2 for security enhancement.

In some embodiments of the present invention, the duration of a security marker embedded in the single-tone signal S1′ may be identical to a duration of a security marker embedded in the single-tone signal S1, and/or the duration of a security marker embedded in the single-tone signal S2′ may be identical to a duration of a security marker embedded in the single-tone signal S2.

In some embodiments of the present invention, the duration of a security marker embedded in the single-tone signal S1′ may be different from a duration of a security marker embedded in the single-tone signal S1 for security enhancement, and/or the duration of a security marker embedded in the single-tone signal S2′ may be different from a duration of a security marker embedded in the single-tone signal S2 for security enhancement.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A channel sounding method for performing distance estimation based on phase-based ranging, comprising:
generating a first single-tone signal with at least one security marker embedded therein for a first tone duration; and
during the first tone duration, transmitting the first single-tone signal from a first wireless communication device to a second wireless communication device.

2. The channel sounding method of claim 1, wherein a number of security markers embedded in the first single-tone signal is known to both of the first wireless communication device and the second wireless communication device before transmission of the first single-tone signal.

3. The channel sounding method of claim 1, wherein at least one of a location and a duration of each security marker embedded in the first single-tone signal is known to both of the first wireless communication device and the second wireless communication device before transmission of the first single-tone signal.

4. The channel sounding method of claim 1, further comprising:
generating a second single-tone signal with at least one security marker embedded therein for a second tone duration; and
during the second tone duration, transmitting the second single-tone signal from the first wireless communication device to the second wireless communication device;
wherein a location of a second security marker embedded in the second single-tone signal is identical to a location of a first security marker embedded in the first single-tone signal.

5. The channel sounding method of claim 1, further comprising:
generating a second single-tone signal with at least one security marker embedded therein for a second tone duration; and
during the second tone duration, transmitting the second single-tone signal from the first wireless communication device to the second wireless communication device;
wherein a location of a second security marker embedded in the second single-tone signal is different from a location of a first security marker embedded in the first single-tone signal.

6. The channel sounding method of claim 1, further comprising:
generating a second single-tone signal with at least one security marker embedded therein for a second tone duration; and
during the second tone duration, transmitting the second single-tone signal from the first wireless communication device to the second wireless communication device;
wherein a duration of a second security marker embedded in the second single-tone signal is identical to a duration of a first security marker embedded in the first single-tone signal.

7. The channel sounding method of claim 1, further comprising:
generating a second single-tone signal with at least one security marker embedded therein for a second tone duration; and
during the second tone duration, transmitting the second single-tone signal from the first wireless communication device to the second wireless communication device;
wherein a duration of a second security marker embedded in the second single-tone signal is different from a duration of a first security marker embedded in the first single-tone signal.

8. The channel sounding method of claim 1, wherein a waveform of each security marker embedded in the first single-tone signal is known to both of the first wireless communication device and the second wireless communication device before transmission of the first single-tone signal.

9. The channel sounding method of claim 1, wherein a waveform of each security marker embedded in the first single-tone signal is unknown to the second wireless communication device before transmission of the first single-tone signal.

10. The channel sounding method of claim 1, wherein each of the first wireless communication device and the second wireless communication device is a Bluetooth (BT) device.

11. A wireless communication device of performing channel sounding for distance estimation based on phase-based ranging, comprising:
a signal generator circuit, configured to generate a first single-tone signal with at least one security marker embedded therein for a first tone duration; and
a transmitter circuit, configured to transmit the first single-tone signal from the wireless communication device to another wireless communication device during the first tone duration.

12. The wireless communication device of claim 11, wherein a number of security markers embedded in the first single-tone signal is known to both of the wireless communication device and the another wireless communication device before transmission of the first single-tone signal.

13. The wireless communication device of claim 11, wherein at least one of a location and a duration of each security marker embedded in the first single-tone signal is known to both of the wireless communication device and the another wireless communication device before transmission of the first single-tone signal.

14. The wireless communication device of claim 11, wherein the signal generator circuit is further configured to generate a second single-tone signal with at least one security marker embedded therein for a second tone duration; the transmitter circuit is further configured to transmit the second single-tone signal to the another wireless communication device during the second tone duration; and a location of a second security marker embedded in the second single-tone signal is identical to a location of a first security marker embedded in the first single-tone signal.

15. The wireless communication device of claim 11, wherein the signal generator circuit is further configured to generate a second single-tone signal with at least one security marker embedded therein for a second tone duration; the transmitter circuit is further configured to transmit the second single-tone signal to the another wireless communication device during the second tone duration; and a location of a second security marker embedded in the second single-tone signal is different from a location of a first security marker embedded in the first single-tone signal.

16. The wireless communication device of claim 11, wherein the signal generator circuit is further configured to generate a second single-tone signal with at least one security marker embedded therein for a second tone duration; the transmitter circuit is further configured to transmit the second single-tone signal from the first wireless communication device to the second wireless communication device during the second tone duration; and a duration of a second security marker embedded in the second single-tone signal is identical to a duration of a first security marker embedded in the first single-tone signal.

17. The wireless communication device of claim 11, wherein the signal generator circuit is further configured to generate a second single-tone signal with at least one security marker embedded therein for a second tone duration; the transmitter circuit is further configured to transmit the second single-tone signal to the another wireless communication device during the second tone duration; and a duration of a second security marker embedded in the second single-tone signal is different from a duration of a first security marker embedded in the first single-tone signal.

18. The wireless communication device of claim 11, wherein a waveform of each security marker embedded in the first single-tone signal is known to both of the wireless communication device and the another wireless communication device before transmission of the first single-tone signal.

19. The wireless communication device of claim 11, wherein a waveform of each security marker embedded in the first single-tone signal is unknown to the another wireless communication device before transmission of the first single-tone signal.

20. The wireless communication device of claim 11, wherein each of the wireless communication device and the another wireless communication device is a Bluetooth (BT) device.
